(19) United States
(12) Patent Application Publication
(10) Pub. No.: US 2008/0012681 A1
(43) Pub. Date: Jan. 17, 2008

(54) THERMALLY PROTECTED ELECTRICAL WIRING DEVICE

(76) Inventors: Paul Kadar, Seaford, NY (US); Dennis A. Oddsen, Eatons Neck, NY (US)

Correspondence Address: PAUL J. SUTTON, ESQ., BARRY G. MAGIDOFF, ESQ.;GREENBERG TRAURIG, LLP, 200 PARK AVENUE, NEW YORK, NY, 10166, US

(21) Appl. No.: 11/752,172

(22) Filed: May 22, 2007

Related U.S. Application Data
(60) Provisional application No. 60/803,328, filed on May 26, 2006.

(51) Int. Cl. H01H 37/00

(52) U.S. Cl. 337/298

(57) ABSTRACT

A receptacle having at least one thermally sensitive electrically conductive element made of, for example, a thermally conductive plastic which either increases or decreases its conductivity when subjected to an increase in temperature. The thermally sensitive element is positioned within the housing of the receptacle such that it makes contact with a blade of an inserted plug or a blade receiving contact in the receptacle. By contacting at least one blade of a plug, or the blade receiving contact in the receptacle, the thermally sensitive element is positioned to detect a temperature rise. A circuit interrupting device located within the receptacle and coupled to the thermally sensitive element is configured to cause electrical discontinuity between the line and load of the receptacle upon the detection of a high heat condition by the thermally conductive element.

This application claims priority pursuant to 35 U.S.C. 119(e) from U.S. Provisional Application having Application No. 60/803,328 filed May 26, 2006.

### FIELD OF THE INVENTION

The present invention relates generally to electrical wiring devices, and, more particularly, to electrical receptacles which can provide protection for an over heat condition.

### BACKGROUND OF THE INVENTION

An electrical plug, when inserted into a wall mounted receptacle, will connect an electrical appliance to a source of AC current. A situation can occur where the connection between the electrical conductors and the blades of the plug, or the connection between the blades of the plug and the blade contacts in the receptacle form a high resistance path which, in turn, can cause a high heat condition. In another situation, a continuous high current flow may also cause a high heat condition. This high heat condition may cause a fire. Because the problem is at the blades of the plug or between the blades of the plug and the blade contacts in the receptacle, the heat condition will not be detected by conventional overload protection devices such as fuses and/or circuit breakers. Electrical appliances such as televisions, refrigerators, toasters, computers and the like can develop internal faults which may cause a high current condition. For example, in an appliance which has an electric motor, such as a refrigerator, the bearings or bushings can wear and lose lubrication, and the electric current needed to operate the motor will increase in order to overcome the increased friction. When this occurs, the current load drawn by the appliance will include the normal operating current plus the additional current needed to overcome the added friction. This total current may exceed the current rating of the electrical cord of the appliance but still be insufficient to open a fuse or trip a protective circuit breaker and may result in a fire as the cord and connected plug heat up.

Accordingly, there is a need for an electrical receptacle which can provide protection against the build up of excessive heat.

### SUMMARY OF THE INVENTION

The present invention relates to an electrical receptacle which has at least one thermally sensitive electrically conductive element located in the receptacle and which is positioned adjacent to or in contact with a blade of an inserted plug, or a blade receiving contact in the receptacle, or both, to sense a high heat condition and which, upon detecting a high heat condition, generates a signal which causes a circuit interrupter to interrupt the flow of power to the receptacle.

In particular, a receptacle in accordance with the present invention includes at least one thermally sensitive electrically conductive element which can be, for example, a simple thermal fuse, a thermocouple or a thermally conductive plastic which either increases or decreases its conductivity when subjected to an increase in temperature. In the description which follows, the thermally sensitive electrically conductive element is referred to as a “thermally sensitive element”. The thermally sensitive element is positioned within the housing of the receptacle such that when the blades of a plug are inserted into the receptacle, the thermally sensitive element makes contact with at least one of the blades of the plug. Accordingly, by contacting at least one blade of a plug, the thermally sensitive element is positioned to detect a temperature rise in the at least one blade of the plug in the receptacle. A circuit interrupting device which can be located either within or outside of the receptacle and coupled to the thermally sensitive element is configured to cause electrical discontinuity between the line and load of the receptacle upon the occurrence of a high heat condition.

The electrical receptacle includes a housing having an interior surface, wherein the housing includes at least one pair of laterally spaced apertures for receiving the blades of a plug. At least one pair of receptacle contacts provide a receptacle terminal for enabling current to pass from the electrical receptacle through the blades of a plug to an electrical appliance. Disposed within the housing, a thermally sensitive element is positioned near a respective one of the pair apertures such that when the pair of blades of a plug are inserted in the pair of apertures of the receptacle, the thermally sensitive clement makes contact with a respective one of the pair of blades of the plug. A circuit interrupting device disposed within the housing is configured to cause electrical discontinuity between the line and load of the receptacle upon the occurrence of an over heat condition. When the temperature of at least one of the blades rises above a predefined temperature range, a thermal sensing circuit which is coupled to the thermally sensitive element transmits a signal to the circuit interrupting device to disconnect power between the line and load receptacle terminals.

The electrical receptacle may include one or a pair of thermally sensitive elements. When one thermally sensitive element is used, it is located in the receptacle and positioned to be adjacent to or contact a blade of an inserted plug. When a pair of thermally sensitive elements are used, the pair of thermally sensitive elements are positioned to be adjacent to or contact both blades of a plug inserted into the receptacle. A sensing circuit coupled to one or both of the thermally sensitive elements is configured to cause electrical discontinuity between the line and load terminals of the receptacle when the thermally sensitive element detects the occurrence of a high heat condition in either one or both blades of the plug.

The electrical receptacle may have one or a pair of thermally sensitive elements. When one thermally sensitive element is used, it is located in the receptacle and positioned to be adjacent to or contact a blade receiving contact located in the receptacle. When a pair of thermally sensitive elements are used, the pair of thermally sensitive elements are positioned to be adjacent to or contact both blade receiving contacts located in the receptacle. A sensing circuit coupled to the thermally sensitive element(s) is configured to cause electrically discontinuity between the line and load of the receptacle when the thermally sensitive element(s) detects the occurrence of a high heat condition in either one or both blades of the plug.

The electrical receptacle may include two separate thermally sensitive elements or two pairs of thermally sensitive elements. When two separate thermally sensitive element are used, one is located in the receptacle and positioned to be adjacent to or contact a blade receiving contact located in the receptacle and the second is positioned to be adjacent to or contact the blade of an inserted plug. When two pairs of thermally sensitive elements are used, one pair of thermally sensitive elements is positioned to be adjacent to or contact both blade receiving contacts located in the receptacle and the other pair of thermally sensitive elements is positioned to be adjacent to or contact both blade receiving contacts located in the receptacle. A sensing circuit coupled to the thermally sensitive elements is configured to cause electrically discontinuity between the line and load of the receptacle when the thermally sensitive elements detects the occurrence of a high heat condition in either one or both blades of the plug or the blade receiving contacts in the receptacle.

In each of the devices described above, the interrupting circuit, which can be a GFCI, can be located either within or external to the receptacle.

### BRIEF DESCRIPTION OF THE DRAWINGS

Other aspects, features, and advantages of the present invention will become more fully apparent from the following detailed description, the appended claim, and the accompanying drawings in which similar elements have similar reference numerals:

FIG. 1 shows a perspective view of an electrical receptacle;

FIG. 2A is a cross-sectional view of FIG. 1 taken along Section line A-A showing a first embodiment having one thermally sensitive element;

FIG. 2B is a cross-sectional view of FIG. 1 taken along Section line A-A showing a second embodiment having a pair of thermally sensitive elements;

FIG. 3A is a cross-sectional view of FIG. 1 taken along Section line A-A showing a third embodiment having one thermally sensitive element;

FIG. 3B is a cross-sectional view of FIG. 1 taken along Section line A-A showing a fourth embodiment having a pair of thermally sensitive elements;

FIG. 4A is a cross-sectional view of FIG. 1 taken along Section line A-A showing a fifth embodiment having two thermally sensitive elements at different locations;

FIG. 4B is a cross-sectional view of FIG. 1 taken along Section line A-A showing a sixth embodiment having two pairs of thermally sensitive elements at different locations;

FIG. 5 is a schematic diagram of a circuit for detecting an over heat condition; and

FIG. 6 is a block diagram of a circuit for detecting an over heat condition.

### DETAILED DESCRIPTION

There is disclosed a wiring device such as an electrical receptacle which, upon the occurrence of a high heat or over-temperature condition at the blade contacts of an inserted plug or the blade receiving contacts in the receptacle, causes the electrical connection between line side terminals and the load side terminals of the receptacle to be interrupted. The receptacle includes at least one thermally sensitive element which is made of a electrically conductive plastic that increase or decrease its resistance and, therefore, changes its conductivity when it is subjected to an increasing temperature. Thus, where the resistance of the electrically conductive plastic decreases with heat, the conductivity of the thermally sensitive element will increase when it is positioned next to or is in contact with a blade of a plug located in a receptacle which is increasing in temperature which may be due to an increase in current flow. By placing the thermally sensitive element or elements within the housing of the electrical receptacle near the apertures where the blades of a plug are inserted, the temperature of the blades of the plug can be sensed by the thermally sensitive elements. In particular, the resistance of the thermal sensing element varies with temperature such that the current that the thermal sensing element draws varies. When the current draw of the thermal sensing element rises above a predetermined level, the device will trip.

The thermally sensitive elements can be moulded in place in the cavity of a receptacle and strategically positioned to contact the blades to enable a connected circuit interrupting circuit to detect a rise in temperature. When the temperature rises above a predetermined temperature threshold, the thermally sensitive elements will become more conductive and the current flow through the elements will increase. The circuit interrupting circuit monitors the current through the thermally sensitive elements. When a high temperature condition sensed by the thermally sensitive elements is detected by the circuit interrupting device, such as a GFCI, current flow through the receptacle is interrupted. In this way the electrical receptacle protects itself from a thermal fault (i.e. over-heating).

Thermally sensitive elements can have either a positive or negative temperature coefficient. Thus, the resistance of the material varies with temperature. Pure metals have a positive value of temperature coefficient of resistivity, which means that their resistance increases with increasing temperature. For example, the resistance of pure metals such as silver, copper and aluminum increases as the temperature increases. There are also materials in which the resistance decreases with increasing temperature. A thermistor is an example of such a material. It is made of semiconductor material such as oxides of manganese, nickel and/or cobalt mixed in the desired proportion with a binder and pressed into shape. Thermistors are sensitive to even small changes of temperature and, therefore, they are often used as thermometers.

Thermally sensitive elements can be made from metals and ceramics, however, a preferred embodiment can be made from thermally conductive plastics which can be insert molded into the receptacle housing.

Thermally conductive plastics offer the heat transfer capability of metals and ceramics while maintaining the design, performance and cost advantages of conventional plastics. Polymers or plastics by their nature are inherent thermal insulators. However, recent developments have established injection molding grade plastics with thermal conductivities in excess of 100 times the conductivity of the base resin.

There is a class of polymers which is modified from existing base polymers such as nylon and polycarbonate. These polymers can be either thermally conductive or electrically and thermally conductive. Any suitable thermally conductive polymer may be selected to use with the device such as polymer reinforced with carbon or ceramic. An example of one such polymer is CoolPoly® E-Series thermally conductive plastics made by Cool Polymers, exhibit electrical conductivity in addition to their thermal conductivity. The respective electrical conductivity of these thermally conductive plastics, measured as electrical resistivity, is commonly in the range 0.1 to 10,000 ohm-cm; wherein unmodified plastics which are good electrical insulators measure in the range of 10¹² to 10¹⁶ ohm-cm, and metals which are good electrical conductors measure in the range of 10⁻⁶ to 10⁻¹ ohm-cm. The thermal conductivity of these thermally conductive plastics range from 1.0 Watts/meter-Kelvin (W/mK) to 100 W/mK. This level of thermal conductivity in a plastic is 5 to 500 times the value of conventional plastics.

Due to the electrically and thermally conductive polymers that make up the thermally conductive elements, the polymer acts as a circuit element, where the change of its electrical properties with temperature can cause a change in electrical current flowing through the polymer. If the temperature of a prong of a plug rises above a pre-defined range, the resistance of the thermally sensitive elements in contact with the prong will change and its conductivity will change. At this time, the circuit interrupting device will detect an increase in temperature which is determined by the amount of current that the thermally sensitive elements are conducting. Accordingly, the circuit interrupting device, which is located in the receptacle, will trip and interrupt the flow of current through the electrical receptacle. Thus, an over-heat condition in the receptacle is avoided.

One such circuit interrupting device which can provide protection is a ground fault circuit interrupter (GFCI) as disclosed in commonly owned patent, U.S. Pat. No. 4,595,894, which is incorporated herein in its entirety by reference. This patent describes a family of resettable circuit interrupting devices capable of detecting a ground fault condition and then breaking an electrical connection between the line side and the load side of an electrical wiring device such as a receptacle, where the line side of the receptacle is connected to a source of power and the load side of the receptacle is connected to one or more loads. Such devices may be reset after they trip.

However, a GFCI offer no protection against a fault which can cause a high heat condition at a plug and/or at a receptacle.

Accordingly, the electrical receptacle in accordance with the present invention may be perceived as an extension of existing personnel protection technology of resettable circuit interrupting devices, including ground fault circuit interrupters (GFCI's), arc fault circuit interrupters (AFCI's), immersion detection circuit interrupters (IDCI's), and appliance leakage circuit interrupters (ALCI's).

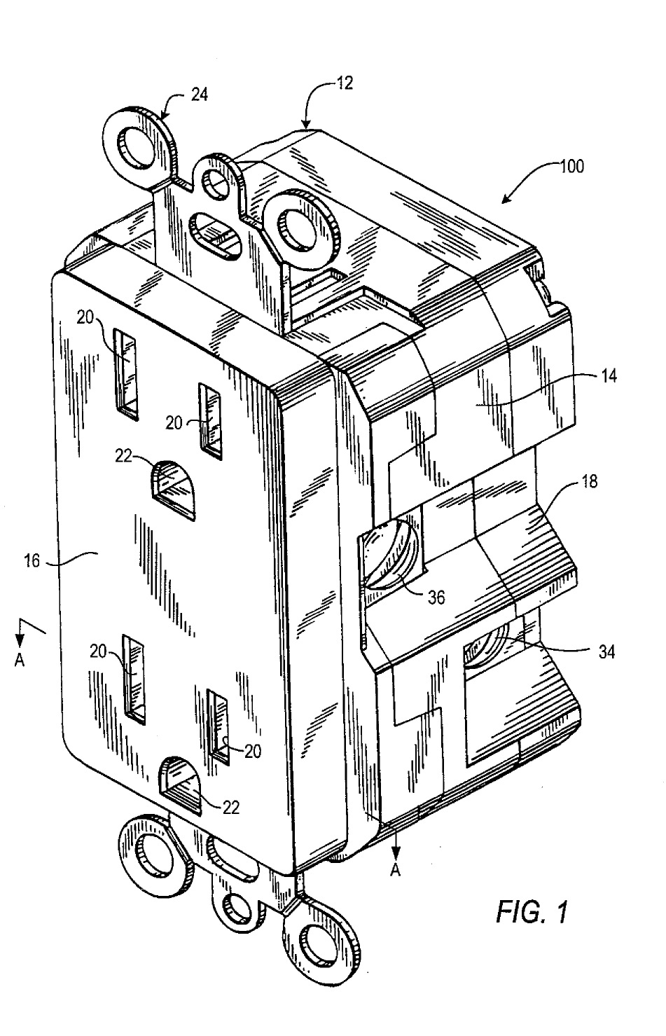

Referring to FIG. 1, there is shown a perspective view of an electrical receptacle 100 in accordance with the principles of the present invention. Electrical receptacle 100 includes housing 12 having of a central body 14 to which a face or cover portion 16 and a rear portion 18 are secured. The face portion 16 has entry ports 20 for receiving normal or polarized blades of a male plug of the type normally found at the end of an appliance cord set, as well as ground prong receiving openings 22 to accommodate a three blade plug. The receptacle includes a ground/mounting strap 24 used to fasten the receptacle to a junction box (not shown).

In those instances where the receptacle is a GFCI, a test button will extend through an opening in the face portion 16 of the housing 12. The test button is used to activate a test operation which tests the operation of the circuit interrupting portion (or circuit interrupter) disposed in the receptacle. The circuit interrupting portion is used to break electrical continuity in one or more conductive paths between the line and load of the receptacle. A reset button can extend through an opening in the face portion of the housing. The reset button is used to activate a reset operation which reestablishes electrical continuity in the open conductive paths in the receptacle.

Electrical connections to existing household electrical wiring are made via binding screws 34 and 36, where screw 34 is a line phase connection and screw 36 is a load phase connection. An additional pair of line and load neutral binding screws are located on the opposite side of the receptacle 100. These additional binding screws provide line and load neutral connections, respectively. The circuit interrupter may be of the type disclosed in U.S. Pat. No. 4,595,894, which is incorporated herein in its entirety by reference.

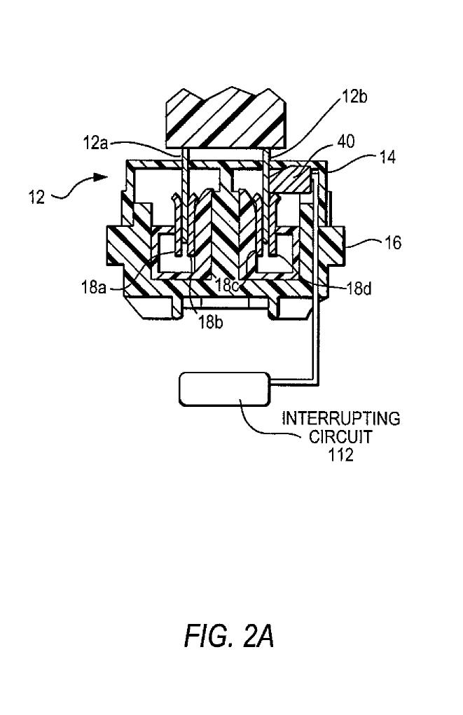

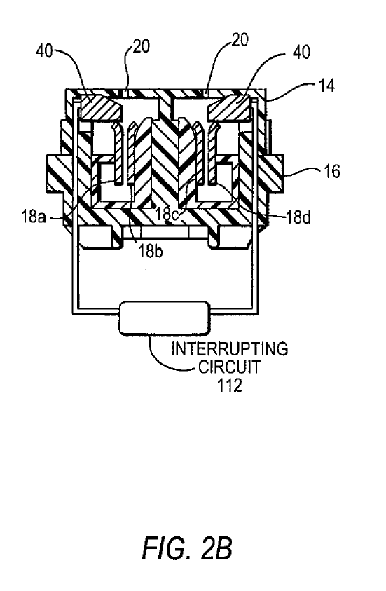

Referring to FIG. 2A, there is shown a cross-sectional view of FIG. 1 taken along Section line A-A of a first embodiment having one thermally sensitive element and a plug inserted in the receptacle. A thermally sensitive element 40 is located near one of the plug blade openings 20 just behind the receptacle face and is positioned to contact blade 12b of a plug located in the receptacle. The thermal sensitive element 40 can have a positive or negative temperature coefficient. In FIG. 2A, reference numerals 12a and 12b designate the blades of a plug, reference numerals 18a, 18b and 18c, 18d designate the two receptacle contacts which receive the blades of a plug and reference numeral 14,16 is the receptacle cover and base.

Each thermally sensitive element can made of an electrically conductive grade of thermally conductive plastics which exhibit either an increase or a decrease in resistance as its temperature rises. As such, when the temperature of the blades of a plug rises, the thermally sensitive element is heated and the resistance of the thermally sensitive element either increases or decreases. The change in resistance of the thermally sensitive element either decreases or increases to control the amount of current that flows to the interrupting circuit such as a GFCI connected to the thermally sensitive elements. The resistance of each thermally sensitive element can be substantially proportional to its temperature. As such, when the blades of a plug are inserted into the electrical receptacle, the temperature of the blades affects the temperature of the thermally sensitive elements and, therefore, the conductivity of the thermally sensitive element. As the temperature of the blades rise above a predetermined temperature, the current through the thermally sensitive element will change. Thus, when the temperature of a blade rises, the thermally sensitive element associated with that blade will sense this rise and pass more or less current, depending upon its characteristics. At some value of current the interrupting circuit 112 connected to the thermally sensitive element will interrupt the flow of current through the receptacle. Thus, the conductive path between the input terminals and output terminals of the receptacle will be interrupted. Accordingly, the electrical receptacle is able to protect itself from a thermal fault (i.e. over-heating). As such, the receptacle in accordance with the present invention may be referred to as a thermal fault circuit interrupter (TFCI).

The thermally sensitive element can be made of an electrically conductive grade of thermally conductive plastics which exhibit a negative temperature coefficient when heated. In this instance, the resistivity of the thermally sensitive elements will decreases with increase in temperature. As noted above, the interrupting circuit can be designed to detect a decrease of current flow through the thermally sensitive element rather than detect an increase in current when the temperature of the blade rises. With either embodiment, either an increase or a decrease in current flow, the interrupting circuit can be designed to generate a signal which will cause electrical discontinuity between the line and load receptacle terminals upon detection of an over temperature condition.

Referring to FIG. 2B, there is shown a cross-sectional view of FIG. 1 taken along Section line A-A of a second embodiment having a pair of thermally sensitive elements 40. A plug is not show in this Fig. A thermally sensitive element 40 is located near each one of the plug blade openings 20 just behind the receptacle face and the two thermally sensitive elements 40 are positioned to contact the two blades of a plug located in the receptacle. Thermally sensitive elements 40 can have a positive or negative temperature coefficient. As with FIG. 2A, an interrupting circuit 112 is connected to the elements 40 to interrupt the flow of current through the receptacle when a high heat condition is detected by one or both of the thermally sensitive elements.

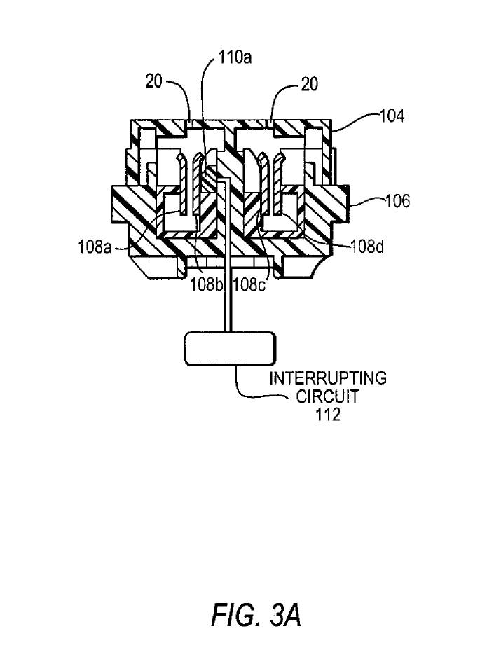

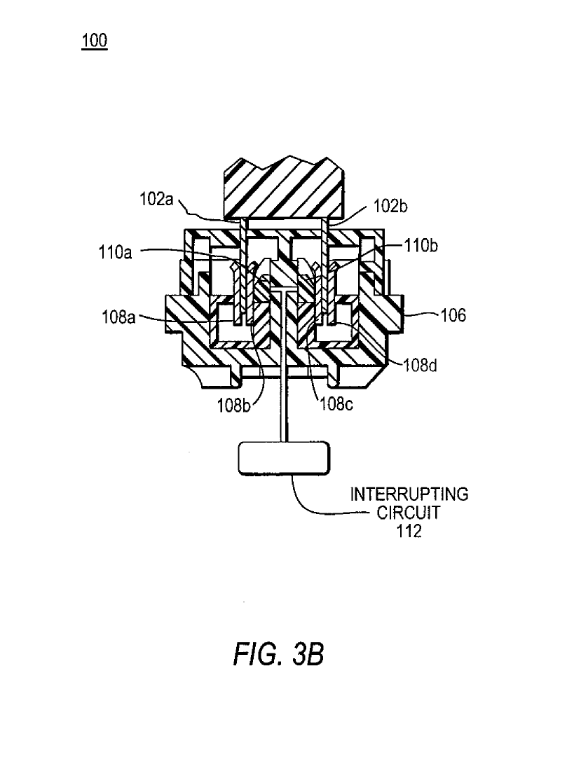

Referring to FIG. 3A, there is shown a cross-sectional view of FIG. 1 taken along Section line A-A of a third embodiment having one thermally sensitive element located to sense the heat of one blade receiving contact in the receptacle positioned to receive a blade of an inserted plug. The plug is not shown. The thermally sensitive element 110a is located to contact one of the blade receiving contacts 108a, 108b located in the body of the receptacle behind plug blade openings 20 and behind the receptacle face. Thermal sensitive element 110a can have either a positive or a negative temperature coefficient. As with FIG. 2A, an interrupting circuit 112 is connected to the elements 110a to interrupt the flow of current through the receptacle when a high heat condition is detected by the thermally sensitive element.

Referring to FIG. 3B, there is shown a cross-sectional view of FIG. 1 taken along Section line A-A of a fourth embodiment having a pair of thermally sensitive elements 110a, 110b located to sense the heat in both blade receiving contacts in the receptacle which are positioned to receive the blades 102a, 102b of an inserted plug. The thermally sensitive element 110a is located near or contacts one of the blade receiving contacts 108a, 108b located in the body of the receptacle behind the plug blade openings in the receptacle; and thermally sensitive element 110b is located near or contacts the other blade receiving contacts 108c, 108d located in the body of the receptacle behind plug blade openings. Thermally sensitive elements 110a, 110b can have either a positive or a negative temperature coefficient. As with FIG. 2A, an interrupting circuit 112 is connected to the elements 110a, 110b to interrupt the flow of current through the receptacle when a high heat condition is detected by the thermally sensitive elements.

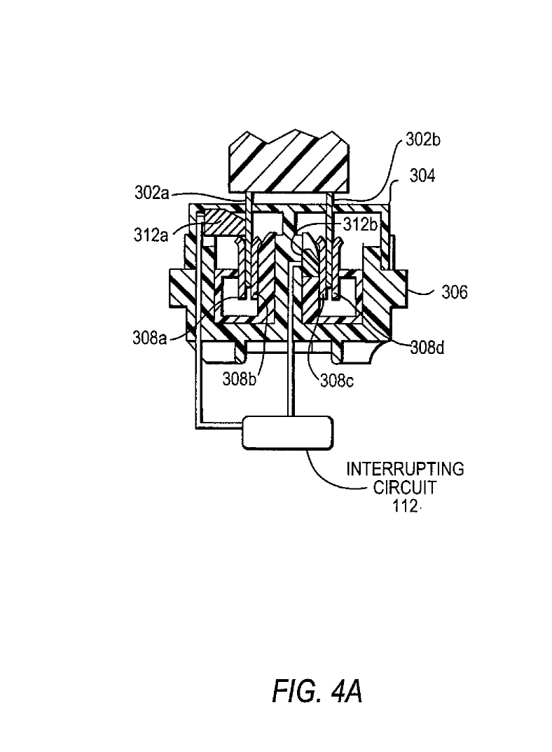

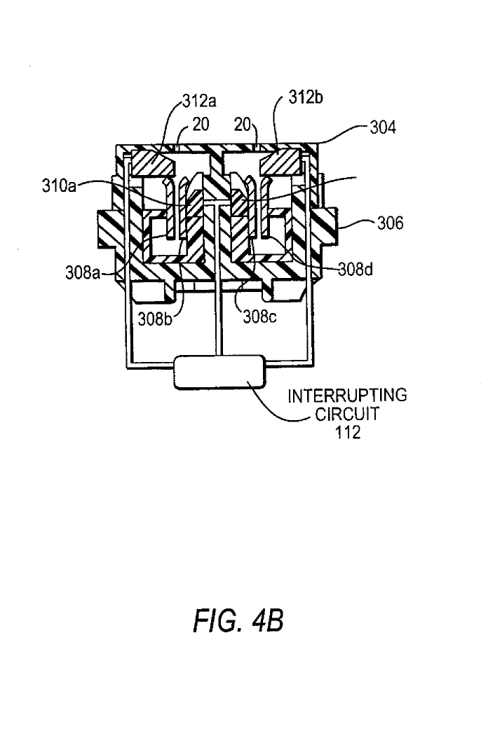

Referring to FIG. 4A, there is shown a cross-sectional view of FIG. 1 taken along Section line A-A of FIG. 1 of a fifth embodiment having a pair of thermally sensitive elements 312a, 312b located to sense the heat in one blade of an inserted plug and in one blade receiving contact 308c located in the body of the receptacle. The thermally sensitive element 312a is located in the body of the receptacle behind a plug blade opening and is positioned to contact a blade 302a of a plug located in the receptacle. Thermally sensitive element 312b is located near or contacts blade receiving contact 308c located in the body of the receptacle behind the other plug blade openings. Thermally sensitive elements 312a, 312b can have either a positive or a negative temperature coefficient. As with FIG. 2A, interrupting circuit 112 is connected to the elements 312a, 312b to interrupt the flow of current through the receptacle when a high heat condition is detected by the thermally sensitive elements.

Referring to FIG. 4B, there is shown a cross-sectional view of FIG. 1 taken along Section line A-A of FIG. 1 of a sixth embodiment having two pairs of thermally sensitive elements located in the body of the receptacle where one pair of thermally sensitive elements is positioned to sense the heat in each of the two blades of an inserted plug, not shown, and the other pair of thermally sensitive elements is positioned to sense the heat in each of the blade receiving contacts in the receptacle. The thermally sensitive elements 312a, 312b are located in the body of the receptacle behind the plug blade openings 20 and are positioned to contact the blades of a plug, not shown, which is located in the receptacle. Thermally sensitive elements 310a, 310b are located near or contact blade receiving contacts 308b and blade receiving contacts 308c, both of which are located in the body of the receptacle behind the plug blade openings 20. Thermally sensitive elements 312a, 312b, 310a, 310b can have either a positive or a negative temperature coefficient. As with FIG. 2A, interrupting circuit 112 is connected to the elements 312a, 310a, 312b and 310b to interrupt the flow of current through the receptacle when a high heat condition is detected by the thermally sensitive elements.

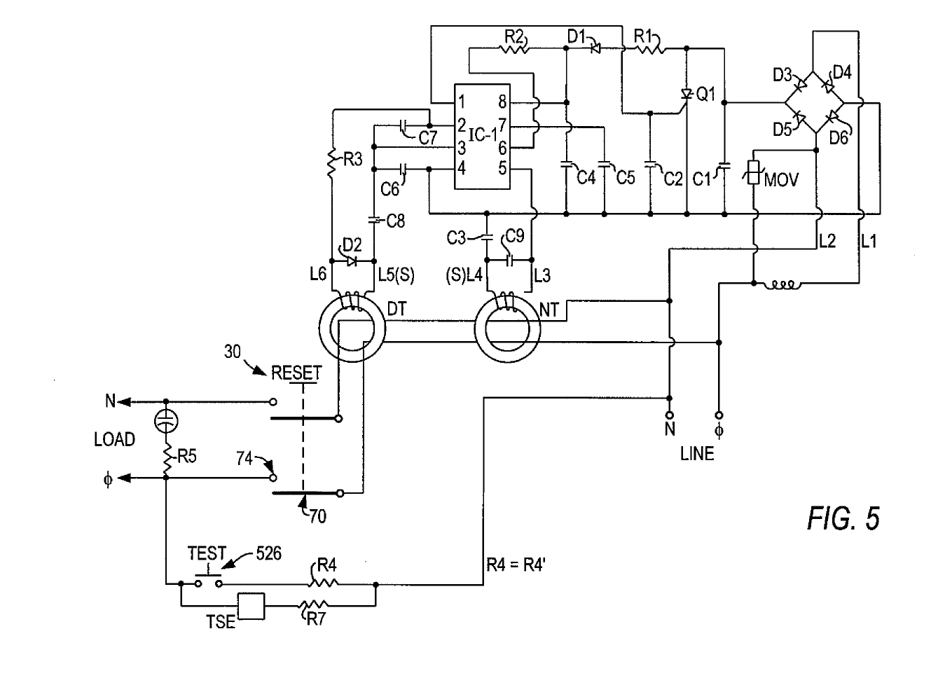

Referring to FIG. 5, there is shown a schematic diagram of an interrupting circuit for interrupting power to the load of the receptacle such as the circuit in a GFCI receptacle which can be used with the thermally sensitive elements here disclosed when a high heat condition occurs. A detailed description of a GFCI receptacle is provided in U.S. Pat. No. 4,595,894 which is incorporated herein in its entirety by reference. The trip mechanism of the GFCI is activated in response to the sensing of a high heat condition by, for example, the circuit shown in FIG. 5 which is a conventional circuit for detecting ground faults and includes a differential transformer that senses current imbalances. In FIG. 5, the thermally sensitive element TSE (or elements) is coupled in parallel with test switch 526 and resistor R4. Depending on the electrical conducting characteristics of the thermally sensitive element TSR, a resistor R7 connected in series with the element TSE may be needed.

In still another embodiment where the thermally sensitive element is an electrically and thermally conductive polymer, the polymer itself can act as a circuit element. In this arrangement, the change of electrical properties with temperature can cause a change in the electrical current in the circuit. This varying current can then be used in conjunction with an LED which will emit light of varying wavelengths (i.e. color) and intensity depending on the current. The varying parameters of the LED output can then be detected with an optical sensor element which interfaces with electronic circuitry, wherein the optical sensor measures the difference in the LED wavelength and transmits a signal to a thermal cutout within the receptacle. The thermal cutout can be implemented using a thermally sensitive bimetal snap-element with double contacts that either opens or closes an electrical circuit by switching at a pre-set response temperature, wherein reset can follow, either manually or automatically after a drop in temperature. Accordingly, the thermal cutout positioned within the receptacle will switch open at a pre-set response temperature and, thereby, open the connection between the power supply and the load. In addition, as an enhanced feature, the output of the LED can be used to visually indicate the state of the device or the LED can be de-energized when the polymer reaches a certain temperature. In summary, the thermal sensing circuit can comprise an LED and an optical sensor element.

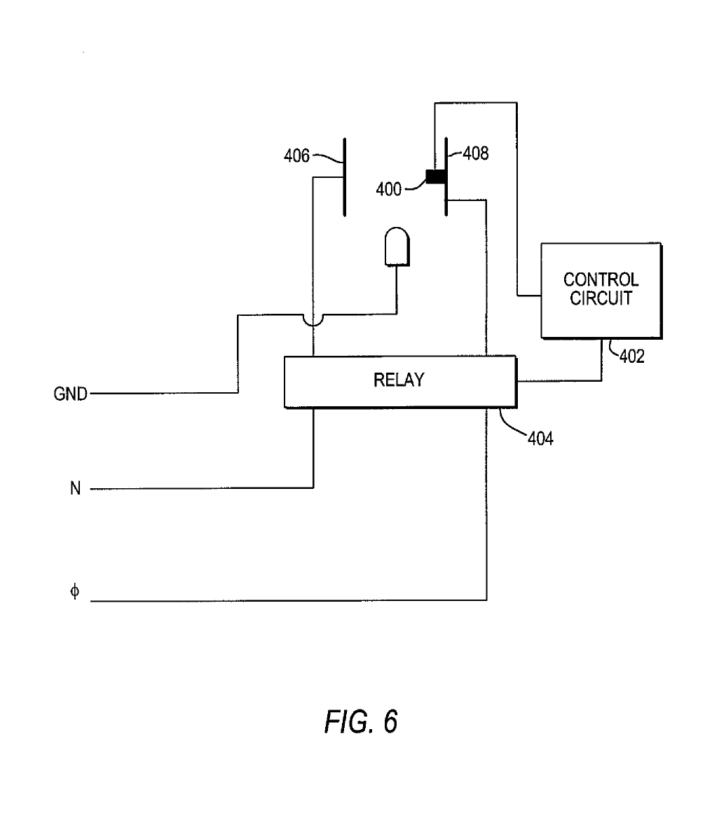

Referring to FIG. 6, there is disclosed a block diagram of a circuit for detecting an over heat condition in an electrical wiring device. In this embodiment, when the thermal sensor 400 detects a temperature above a predefined level, a control circuit 402 is activated to operate a relay 404 which opens the circuit between the Neutral and Phase conductors and the contacts 406, 408.

The receptacle can either include its own circuit interrupter (thermal fuse, relay, or solenoid type circuitry found in GFCI's), or it can place an electrical fault on the power line such that an upstream GFCI or AFCI type device would trip the circuit. Thus, the circuit interrupting components need not be included in every receptacle. The fault can be a simple ground fault or a fault to simulate a line-load reversal of a GFCI type device. Either way, an upstream GFCI type device would trip the circuit.

The foregoing has outlined, rather broadly, the preferred feature of the present invention so that those skilled in the art may better understand the detailed description of the invention that follows. Those skilled in the art should appreciate that they can readily use the disclosed conception and specific embodiment as a basis for designing or modifying other structures for carrying out the same purposes of the present invention. While the present invention is embodied in hardware, alternate equivalent embodiments may be employed. Those skilled in the art should also realize that such equivalent constructions do not depart from the spirit and scope of the invention in its broadest form.

The terms and expressions which have been employed in the foregoing specification are used herein as terms of description and not of limitation, and there is no intention in the use of such terms and expressions of excluding equivalents of the features shown and described or portions thereof, it being recognized that the scope of the invention is defined and limited only by the claims.

What is claimed is:

1. An electrical device comprising:
a housing;
at least one input conductor disposed at least partially within said housing and capable of being electrically connected to a source of electricity;
at least one output conductor disposed within said housing and capable of conducting electrical current to a load when electrically connected to said at least one input conductor;
at least one thermally sensitive element disposed within said housing; and
a circuit cutoff disposed within said housing coupled to said thermally sensitive element and configured to break said electrical connection between said input and output conductor when the thermally sensitive element draws an amount of current above a predefined level.

2. The electrical device of claim 1 wherein said at least one thermally sensitive element is located to sense the temperature of a plug blade inserted into said receptacle.

3. The electrical device of claim 1 wherein said at least one thermally sensitive element is located to sense the temperature of a blade receiving contact located in said receptacle.

4. The electrical device of claim 1 further comprising:
a pair of thermally sensitive elements located to sense the temperature of plug blade inserted into the phase receiving contact and the blade inserted into the neutral contact, respectively.

5. The electrical device of claim 1 further comprising:
a first thermally sensitive element located to sense the temperature of a plug blade while inserted into said receptacle; and
a second thermally sensitive element located to sense the temperature of a blade receiving contact in said receptacle.

6. The electrical device of claim 1 wherein said thermally sensitive element is an electrically conductive plastic that exhibits an increase in resistance with an increase in temperature.

7. The electrical device of claim 1 wherein said thermally sensitive element is an electrically conductive plastic that exhibits a decrease in resistance with an increase in temperature.

8. The electrical device of claim 1 wherein said thermally sensitive element is a thermal fuse.

9. The electrical device of claim 1 wherein said thermally sensitive element is a thermocouple.

10. The electrical device of claim 1 where the electrical device is a receptacle.

11. The electrical device of claim 10 where the receptacle is a GFCI receptacle.

12. The electrical device of claim 11 where the circuit cutoff is a ground fault interrupter circuit.

13. The electrical device of claim 11 further comprising:
at least one receptacle that has a thermal sensor but no circuit interrupter located down stream of the GFCI receptacle wherein when an over temperature exists, the thermal sensor in the at least one receptacle creates a ground fault or a ground neutral fault which causes the upstream GFCI to trip off the power.

14. A circuit comprising:
a GFCI;
at least one receptacle that has a thermal sensor but no circuit interrupter located down stream of the GFCI receptacle wherein when an over temperature exists, the thermal sensor in the at least one receptacle creates a ground fault or a ground neutral fault which causes the upstream GFCI to trip off the power.

15. The electrical device of claim 1 wherein the at least one of the thermally sensitive element is a conductive plastic coupled to control the light from an LED to be on, off or variable; and
an optical sensor coupled to detect the output of the LED to operate the circuit cutoff.

16. The electrical device of claim 15 wherein the LED is visible to a user.

17. A method of controlling the flow of electricity through an electrical device comprising:
connecting an electrical device to a source of power;
detecting the temperature of at least an element within the device; and
breaking electrical continuity within the electrical device when the temperature of the at least an element exceeds a predetermined threshold.

18. The method according to claim 17 wherein the electrical device is a receptacle providing power to a user inserted plug.

19. The method according to claim 18 wherein the electrical device is a GFCI.
